(19) United States
(12) Patent Application Publication
(10) Pub. No.: US 2012/0217026 A1
(43) Pub. Date: Aug. 30, 2012

(54) AEROSOL FIRE SUPPRESSION APPARATUS WITH HIGH TEMPERATURE ABLATION RESISTANT INSULATING LAYER AND PREPARATION METHOD THEREOF

(75) Inventors: Hongbao Guo, Xi'an (CN); Sanxue Zhang, Xi'an (CN); Chenggong Ma, Xi'an (CN); Weipeng Zhang, Xi'an (CN)

(73) Assignee: SHAANXI J & R FIRE FIGHTING CO. LTD., Xi'an (CN)

(21) Appl. No.: 13/499,674

(22) PCT Filed: Jul. 3, 2010
(86) PCT No.: PCT/CN2010/074963

§ 371 Date: Mar. 30, 2012

(30) Foreign Application Priority Data
Nov. 20, 2009 (CN) 200910219106.X

(51) Int. Cl. A62C 35/02; A62C 5/00

(52) U.S. Cl. 169/6; 29/527.1

(57) ABSTRACT

The present invention provides an aerosol fire suppression apparatus with a high temperature ablation resistant thermal insulating layer and preparation method thereof, wherein the aerosol fire suppression apparatus comprises enclosure, thermal insulating layer, aerosol generating chemical agent, cooling material, and initiator. The thermal insulating layer is made of silicone rubber material, comprising silicone rubber substrate, cross-linking agent, fire retarding agent, high temperature resistant material, coupling agent and catalyst. The preparation method of the aerosol fire suppression apparatus comprises: casting aerosol generating chemical agent and silicone rubber into an integral piece in a mold, and cross-linking and solidifying at room temperature, to form a thermal insulating layer; loading the initiator in the chemical agent, filling a cooling material over the initiator, and covering the cooling material with a screen; loading the thermal insulating layer that contains the aerosol generating chemical agent, initiator, and cooling material into the enclosure of the apparatus, and sealing the thermal insulating layer with a cover. Compared to existing apparatuses in the prior art, the apparatus in the present invention has the following advantages: the silicone rubber casting process is simple and suitable for mass production; the silicone rubber thermal insulating layer delivers good heat insulation effect; the packed aerosol generating agent can burn stably without flying flame or explosive burning phenomenon.

### FIELD OF THE INVENTION

The present invention provides an aerosol fire suppression apparatus and preparation method thereof, and especially relates to an aerosol fire suppression apparatus with high temperature ablation resistant insulating layer and preparation method thereof.

### BACKGROUND OF THE INVENTION

Aerosol fire suppression is a fire suppression technique based on initiating explosive devices that has been developed in recent years, with advantages such as simple structure, low cost, high fire suppression efficacy and free of secondary pollution, etc. The fire suppression mechanism of aerosol is: the fire suppression agent releases a great deal of metal ions and oxides in chemical reaction, and these metal ions and oxides react with the active groups in the flames, and thereby block the chain reaction in the flames and get the object of fire suppression. A great deal of heat is generated in the chemical reaction that produces fire suppression aerosol, and may cause secondary fire if the wall temperature of the apparatus is too high. Therefore, the fire suppression apparatus must have a heat insulating material to prevent extremely high wall temperature.

In the prior art, for example, an aerosol fire suppression apparatus that comprises enclosure, cooling area, reaction chamber and thermal insulating layer is disclosed in Patent Application No. 200820110213.X and 02278270.2, wherein the heat insulating material is aluminum silicate plates and rubber plates., Several aerosol fire suppression apparatuses are also disclosed in Patent Application No. 97248609.7, 9912556.4, 01277738.2, and 02262244.6. These apparatuses are similar to each other in structure, and most of them utilize aluminum silicate fibers as the heat insulating material. It is proved that the heating insulation performance of a fire suppression apparatus that utilizes aluminum silicate plates, rubber plates, or aluminum silicate fibers as heat the insulating material is just so-so, and is barely enough to meet the technical specification for the wall temperature of aerosol fire suppression apparatus; in addition, it is a common phenomenon that the enclosure of fire suppression apparatus is ablated. In these apparatuses, the thermal insulating layer is usually packed manually, resulting in three drawbacks: first, the process is complicated and the operating efficiency is low; second, the packing is uneven, resulting in unbalanced heat insulation effect, and therefore the apparatus is often ablated partially; third, the packing amount is difficult to control and normalized.

### SUMMARY OF THE INVENTION

To overcome the drawbacks in existing aerosol fire suppression apparatuses, such as poor heat insulation effect and complicated packing process of the thermal insulating layer, the present invention provides an aerosol fire suppression apparatus that is resistant to high temperature and ablation and has high heat insulation performance, meets the wall temperature criterion specified in the industry standard GA499.1-2004, and can avoid ablation on the surface.

The present invention provides an aerosol fire suppression apparatus with a high temperature ablation resistant thermal insulating layer, comprising enclosure, thermal insulating layer, aerosol generating chemical agent, cooling material and initiator, wherein the thermal insulating layer is made of silicone rubber material, comprising silicone rubber substrate by 30-50 wt %, cross-linking agent by 1-10 wt %, fire retarding agent by 5-50 wt %, high temperature resistant material by 5-50 wt %, coupling agent by 0.1-5 wt % and catalyst by 0.1-5 wt %.

Furthermore, the thermal insulating layer is produced from silicone rubber material by casting.

Furthermore, there are initiator, cooling material, aerosol generating chemical agent and screen layer inside the thermal insulating layer; the thermal insulating layer is fastened in the enclosure of the apparatus; a cover is arranged above the screen layer; an aerosol jet orifice is arranged on the cover.

Furthermore, the silicone rubber substrate is methyl-silicone oil 201, silicone rubber 106 or silicone rubber 107.

Furthermore, the cross-linking agent is phenyl-ethynyl polysiloxane or ethyl orthosilicate.

Furthermore, the coupling agent is γ-aminopropyltriethoxysilane, γ-glycidyletheroxy propyltrimethoxysilane or γ-methacryloxylpropyltrimethoxysilane.

Furthermore, the fire retarding agent is Al(OH)₃, melamine, mica powder or Mg(OH)₂; the high temperature resistant material is Fe₂O₃, hydrotalcite or talcum powder.

Furthermore, the catalyst is N,N,N′,N′-tetramethyl guanidine or dibutyltin dilaurate.

The present invention further provides a preparation method of an aerosol fire suppression apparatus with a high temperature ablation resistant thermal insulating layer, comprising:

Step 1: casting aerosol generating chemical agent 4 and silicone rubber into an integral piece in a mold, and cross-linking and solidifying at room temperature, to form a thermal insulating layer 1;

Step 2: loading an initiator 2 in the chemical agent 4, filling a cooling material 3 over the initiator 2, and covering the cooling material 3 with a screen 5;

Step 3: loading the thermal insulating layer 1 that contains the aerosol generating chemical agent 4, initiator 2, and cooling material 3 into the enclosure 6 of the apparatus, and sealing the thermal insulating layer 1 with a cover 7.

Compared to manually packed aerosol fire suppression apparatuses, the aerosol fire suppression apparatus with a high temperature ablation resistant thermal insulating layer in the present invention has the following advantages: (1) the silicone rubber thermal insulating layer delivers good heat insulation effect; (2) the aerosol generating chemical agent has higher moisture resistance performance and can burn stably, without flying flame or explosive burning phenomenon; (3) the casting and assembly process is simple and suitable for mass production.

### BRIEF DESCRIPTION OF THE DRAWINGS

FIG. 1 is a schematic structural diagram of an aerosol fire suppression apparatus with a silicone rubber thermal insulating layer.

Wherein:
1—thermal insulating layer,
2—initiator,
3—cooling material,
4—aerosol generating chemical agent
5—screen,
6—enclosure,
7—cover,
8—aerosol jet orifice.

### DETAILED DESCRIPTION OF THE EMBODIMENTS

The aerosol fire suppression apparatus with a silicone rubber thermal insulating layer in the present invention will be further detailed with reference to the drawings.

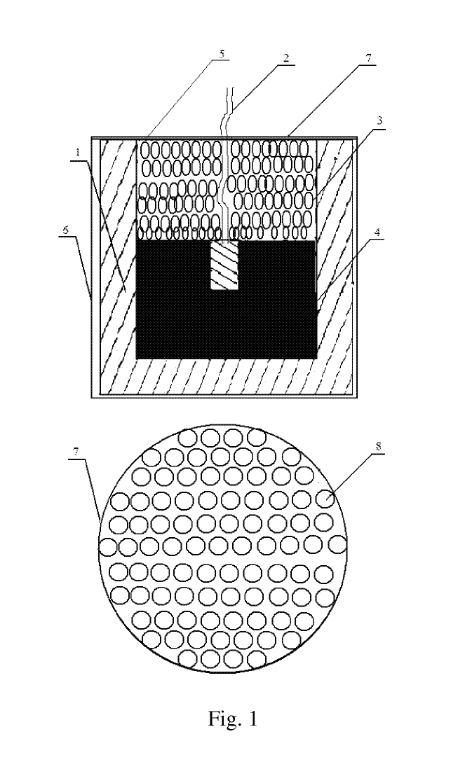

As shown in FIG. 1, the aerosol fire suppression apparatus in the present invention comprises enclosure 6, thermal insulating layer 1, aerosol generating chemical agent 4, cooling material 3 and initiator 2, wherein the thermal insulating layer 1 is made of a material that is different to the legacy material, i.e., the thermal insulating layer 1 is made of silicone rubber material, comprising silicone rubber substrate by 30-50 wt %, cross-linking agent by 1-10 wt %, fire retarding agent by 5-50 wt %, high temperature resistant material by 5-50 wt %, coupling agent by 0.1-5 wt %, and catalyst by 0.1-5 wt %.

The thermal insulating layer 1 is fixed in the enclosure 6 and contains initiator 2, cooling material 3, aerosol generating chemical agent 4 and screen 5. A cover 7 is arranged above the screen 7 and an aerosol jet orifice 8 is arranged on the cover 7.

### EXAMPLE 1

100 g silicone rubber 106 is agitated to homogeneous state and 500 g aerosol generating chemical agent of strontium salt in Φ65 mm diameter is loaded into a mold. In the mold the silicone rubber 106 is casted and vulcanized for 24 h to solidify the cast piece. Then an initiator is loaded into the generating chemical agent and a cooling material 3 is filled over the initiator before the cooling material is covered with a screen. The thermal insulating layer 1 that contains the aerosol generating chemical agent 4, initiator 2 and cooling material 3 is fastened in the enclosure 6 of the apparatus and the thermal insulating layer 1 in the enclosure 6 is sealed with a cover 7. After the apparatus is initiated, aerosol will spurt out of an aerosol jet orifice 8 on the cover 7. The temperatures at the jet orifice, side walls and bottom of the apparatus are measured with a temperature sensing probe. Maximum temperature at the jet orifice: 84° C.; maximum temperature at the side walls: 117° C.; maximum temperature at the bottom: 145° C.

### EXAMPLE 2

150 g silicone rubber 107 is agitated to homogeneous state and 1000 g aerosol generating chemical agent of potassium salt in Φ75 mm diameter is loaded into a mold. In the mold the silicone rubber 107 is casted and vulcanized for 12 h to solidify the cast piece. Then an initiator 2 is loaded into the generating chemical agent 4 and a cooling material 3 is filled over the initiator before the cooling material is covered with a screen 5. The thermal insulating layer 1 that contains the aerosol generating chemical agent 4, initiator 2 and cooling material 3 is fastened in the enclosure 6 of the apparatus and the thermal insulating layer 1 in the enclosure 6 is sealed with a cover 7. After the apparatus is initiated, the temperatures at the jet orifice, side walls, and bottom of the apparatus are measured with a temperature sensing probe. Maximum temperature at the jet orifice: 122° C.; maximum temperature at the side walls: 130° C.; maximum temperature at the bottom: 132° C.

When a fire signal is received, the aerosol fire suppression apparatus with a high temperature ablation resistant thermal insulating layer in the present invention is initiated by the initiator 2. The aerosol generating chemical agent is ignited and fire suppression aerosol is produced, which spurt out of the aerosol jet orifice 8 get the object of fire suppression. The heat released along the jet orifice is absorbed by the cooling material 3 and the heat near the side walls is isolated by the thermal insulating layer 1; therefore, the temperature values at the jet orifice, side walls and bottom can meet the criterion specified in the standard GA499.1-2004.

1. An aerosol fire suppression apparatus with a high temperature ablation resistant thermal insulating layer, comprising enclosure, thermal insulating layer, aerosol generating chemical agent , cooling material, and initiator, characterized in that the thermal insulating layer is made of silicone rubber material, comprising silicone rubber substrate by 30-50 wt %, cross-linking agent by 1-10 wt %, fire retarding agent by 5-50 wt %, high temperature resistant material by 5-50 wt %, coupling agent by 0.1-5 wt % and catalyst by 0.1-5 wt %.

2. The aerosol fire suppression apparatus with a high temperature ablation resistant thermal insulating layer according to claim 1, characterized in that the thermal insulating layer is produced from silicone rubber material by casting.

3. The aerosol fire suppression apparatus with a high temperature ablation resistant thermal insulating layer according to claim 2, characterized in that there are is initiator, cooling material, aerosol generating chemical agent and screen inside the thermal insulating layer; the thermal insulating layer is fastened in the enclosure; a cover is arranged above the screen, and an aerosol jet orifice is arranged on the cover.

4. The aerosol fire suppression apparatus with a high temperature ablation resistant thermal insulating layer according to claim 1, characterized in that the silicone rubber substrate is methyl silicone oil 201, silicone rubber 106 or silicone rubber 107.

5. The aerosol fire suppression apparatus with a high temperature ablation resistant thermal insulating layer according to claim 1, characterized in that the cross-linking agent is phenyl ethynyl polysiloxane or ethyl orthosilicate.

6. The aerosol fire suppression apparatus with a high temperature ablation resistant thermal insulating layer according to claim 1, characterized in that the coupling agent is γ-aminopropyltriethoxysilane, γ-glycidyletheroxypropyltrimethoxysilane or γ-methacryloxyl propyltrimethoxysilane.

7. The aerosol fire suppression apparatus with a high temperature ablation resistant thermal insulating layer according to claim 1, characterized in that the fire retarding agent is Al(OH)₃, melamine, mica powder or Mg(OH)₂.

8. The aerosol fire suppression apparatus with a high temperature ablation resistant thermal insulating layer according to claim 1, characterized in that the high temperature resistant material is Fe₂O₃, hydrotalcite, or talcum powder.

9. The aerosol fire suppression apparatus with a high temperature ablation resistant thermal insulating layer according to claim 1, characterized in that, the catalyst is N,N,N′,N′-tetramethyl guanidine or dibutyltin dilaurate.

10. A preparation method of the aerosol fire suppression apparatus with a high temperature ablation resistant thermal insulating layer according to claim 1, characterized in that the method comprises the following steps:
step 1: casting aerosol generating chemical agent and silicone rubber into an integral piece in a mold, and cross-linking and solidifying at room temperature, to form a thermal insulating layer;
step 2: loading the initiator in the chemical agent, filling a cooling material over the initiator, and covering the cooling material with a screen;
step 3: loading the thermal insulating layer that contains the aerosol generating chemical agent, initiator, and cooling material into the enclosure of the apparatus, and sealing the thermal insulating layer with a cover.
